(19) United States
(12) Patent Application Publication
(10) Pub. No.: US 2007/0109827 A1
(43) Pub. Date: May 17, 2007

(54) Ac to dc converter circuit

(76) Inventor: Moises DelaCruz, Cottage Grove, MN (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 10/581,070

(22) PCT Filed: Dec. 3, 2004
(86) PCT No.: PCT/US04/40612

§ 371 Date: May 31, 2006

Related U.S. Application Data
(60) Provisional application No. 60/528,572, filed on Dec. 10, 2003.
(60) Provisional application No. 60/532,207, filed on Dec. 22, 2003.
(60) Provisional application No. 60/585,447, filed on Jul. 2, 2004.

(51) Int. Cl. H02M 7/537

(52) U.S. Cl. 363/131

(57) ABSTRACT

An AC to DC converter circuit 300 includes a transformer 316 having primary 314 and secondary 320 windings, a rectifier bridge 322 coupled to the secondary winding, a DC filter capacitor 328 coupled to the rectifier bridge, a voltage regulator 330 coupled the DC filter capacitor and to DC output contacts 332, 334. The converter circuit includes an AC reactance 312 coupled in a series circuit with the primary winding and AC input contacts 304, 306. The AC reactance limits AC excitation voltage at the primary winding to less than the AC line voltage.

The present application is based on and claims the benefits of U.S. provisional patent application Ser. No. 60/528,572, filed Dec. 10, 2003, titled “AC to DC power converter with high efficiency conversion,” and U.S. provisional patent application Ser. No. 60/532,207, filed Dec. 22, 2003, titled “Lithium ion battery charger,” and U.S. provisional patent application Ser. No. 60/585,447, filed Jul. 2, 2004, titled “Converter circuit,” the contents of which are hereby incorporated by reference in their entirety.

### BACKGROUND OF THE INVENTION

As illustrated in PRIOR ART FIG. 1A, a DC power supply 100 is energized from an AC power source 102. The power source 102 comprises a regulated AC power line with a nominal line voltage and nominal line frequency. The power supply 100 comprises a transformer 104 with a magnetic core 106 and an excitation winding or primary 108 connected across the power line. The primary 108 conducts a primary current 110 supplied by the AC power source 102. The primary current 110 induces magnetization of the core 106 and provides power to a load on a secondary winding 116.

As illustrated in PRIOR ART FIG. 1B, the transformer 104 (FIG. 1A, 1B) is typically an E-I laminated transformer for 50/60 Hz applications. The transformer 104 has a magnetic core 106 that provides a closed loop, low reluctance, effective magnetic path 210 of length L transverse to an effective magnetic core cross-section 212 with a cross-sectional area AM. The magnetic path 210 surrounds a window 214 with an effective cross sectional area AW. The primary winding 108, as well as the secondary winding 116 pass through the window 214.

In sizing the transformer core 106 for a specified power line frequency (such as 50/60 Hz or 400 Hz) and a specified magnetic core material, the mechanical dimensions AM, AW, L of the transformer core tend to decrease as the power level specification for the power supply decreases. This reduction in mechanical dimensions of the transformer core allows for the possibility of extreme miniaturization of the power supply, provided that other aspects of the power supply can be miniaturized. As the mechanical dimensions of the transformer decrease, the number of turns required in the primary increases for a specified AC power line voltage.

Once the approximate number of turns is determined, then wire diameters are chosen for the primary and secondary windings so that the selected number of primary and secondary turns will substantially fill the window area AW. The window area AW sets a limit on a cross sectional area of windings that can be wound on the transformer 104.

In extending the transformer design process described above to miniaturized power supplies with power levels below about 1 watt, however, additional design problems are encountered due to the extremely small window area AW. A large number of primary winding turns are needed (at line voltage) to prevent saturation of the transformer core 106. In order to fit this large number of primary turns through the window 214 (along with secondary turns), extremely small diameter magnet wire is needed for the primary winding 108. However, the extremely small diameter magnet wire is fragile and breaks easily during manufacturing of the transformer 104. In an effort to overcome this problem, a separate power resistor 112 (FIG. 1A) is placed in series with the primary winding 108 (FIG. 1A) and sized to reduce the primary voltage of the transformer, which allows a smaller number of larger diameter turns to be used for the primary winding. The use of resistor 112 avoids the use of extremely small diameter magnet wire. The power resistor 112, however, is physically large for a selected line voltages in the range of 90-280 VAC, and dissipates a large amount of power that overheats other power supply components (such as bridge and regulator circuits 120) in the close confines of a miniature DC power supply design package 114. Either the benefits of low power consumption, the benefits of freedom from overheating or the benefits of miniaturization are lost when a series power resistor 112 is used.

A method and circuit are needed that provide low power consumption, freedom from overheating, and miniaturization to take advantage of the small transformer size in a low power DC power supply.

### SUMMARY OF THE INVENTION

Disclosed is an AC to DC converter circuit that includes AC input contacts couplable to an AC line voltage, and DC output contacts couplable to a DC load. The converter circuit also includes a transformer having primary and secondary windings, a rectifier bridge coupled to the secondary winding, a DC filter capacitor coupled to the rectifier bridge, and a voltage regulator coupled the DC filter capacitor and to the DC output contacts.

The converter circuit includes an AC reactance coupled in a series circuit with the primary winding and the AC input contacts. The AC reactance limits AC excitation voltage at the primary winding to less than the AC line voltage.

In a preferred embodiment, the AC reactance comprises a capacitor with a capacitive impedance that is greater than the impedance on the primary winding of the transformer. The arrangement provides a desired high efficiency in a low power converter circuit.

Other features and benefits that characterize embodiments of the present invention will be apparent upon reading the following detailed description and review of the associated drawings.

### BRIEF DESCRIPTION OF THE DRAWINGS

FIG. 1A illustrates a PRIOR ART power supply circuit.

FIG. 1B illustrates a PRIOR ART transformer.

FIG. 2 illustrates a first embodiment of a converter circuit.

FIG. 3 illustrates impedances for examples of three AC excitation circuits for primary windings.

FIG. 4 illustrates a second embodiment of a converter circuit.

FIG. 5 illustrates a third embodiment of a converter circuit.

FIG. 6 illustrates a fourth embodiment of a converter circuit.

FIG. 7 illustrates a fifth embodiment of a converter circuit.

FIG. 8 illustrates a sixth embodiment of a converter circuit.

### DETAILED DESCRIPTION OF THE PREFERRED EMBODIMENTS

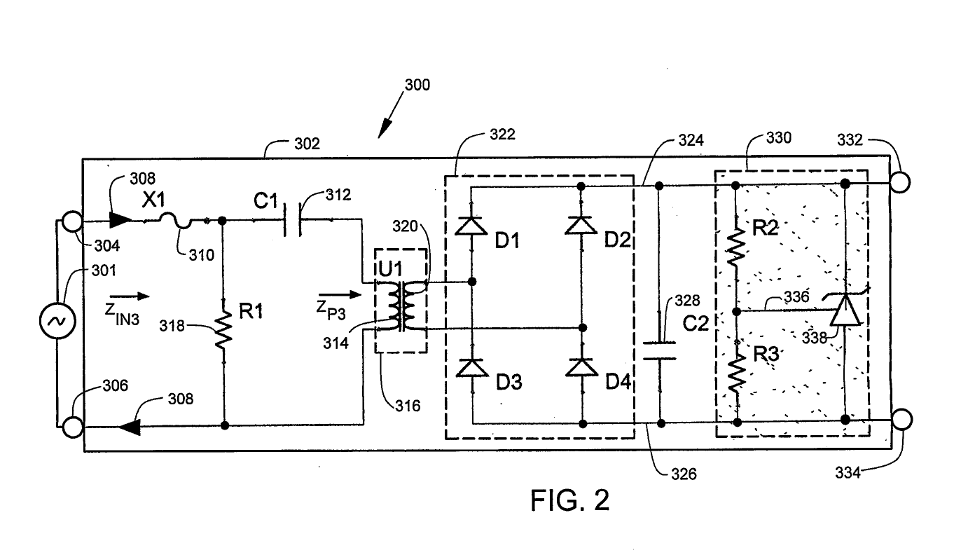

In the embodiments described below in FIGS. 2-8, an AC to DC converter circuit is energized by an AC line voltage at AC input contacts. The converter provides a DC power supply voltage at DC output contacts to a DC load. The converter includes a transformer, a rectifier bridge, a DC filter capacitor and a voltage regulator. An AC reactance (such as a capacitor or inductor) is coupled in a series circuit with the primary winding and the AC input contacts. The AC reactance limits (lowers) AC excitation voltage at the primary winding to less than the AC line voltage. With the lowered excitation voltage, a smaller number of primary winding turns with a larger wire size can be used and still fit into the same transformer core window size that as a winding with more turns and finer, more fragile, wire size that would connect directly to the full AC line voltage. As a result of the addition of the series AC capacitor, the use of smaller, fragile wire sizes is avoided and reliability of the power supply in increased. Also, low power consumption, freedom from overheating and miniaturization are achieved.

FIG. 2 illustrates a miniaturized converter circuit 300 in a housing 302. The converter circuit 300 includes AC contacts 304, 306 for connection to a regulated source of AC voltage 301, for example nominal 115 VAC or 230 VAC power mains. In an application where the housing 302 comprises a plug assembly, the AC contacts 304, 306 can comprise pins or blades extending through the housing 302 that are adapted for plugging into a standard electrical outlet. In applications where the housing 302 encloses a larger apparatus such as a television set, battery charger, or the like, the contacts 304, 306 can comprises circuit board connectors such as pins, sockets, wire leads or the like that connect indirectly to a regulated source of AC power. The miniaturized converter circuit 300 can be integrated with other circuits on a circuit board, in which case the AC contacts 304, 306 typically comprise circuit board leads or pads. The contacts 304, 306 can also comprise a power cord.

An input or excitation current 308 flows mainly through a series circuit that comprises an optional fuse (X1) 310, a capacitor (C1) 312, and a primary winding 314 of a power transformer (U1) 316. Substantially all of the excitation current 308 flows through the primary winding 314 and the capacitor 312, however, an optional bleed resistor (R1) 318 can be provided to discharge any residual charge on capacitor 312 in a fraction of a second when the contacts 304, 306 are disconnected from the source of AC power. In an instance where the contacts 304, 306 are pins or blades that can be unplugged and exposed, the use of the bleed resistor 318 reduces the possibility of an electrical shock. When used, the bleed resistor 318 typically has a resistance of 10 megohms or more and uses a negligible amount of current and power in comparison with that provided to the primary winding 314. The bleed resistor 318 can be connected in a series loop with the primary winding 314 and the capacitor 312 as illustrated. Alternatively, the bleed resistor 318 can be connected in a series loop with only the capacitor 312. In an instance where the contacts are connected to other circuits inside housing 302 that provide a suitable resistive discharge path, the bleed resistor can be omitted.

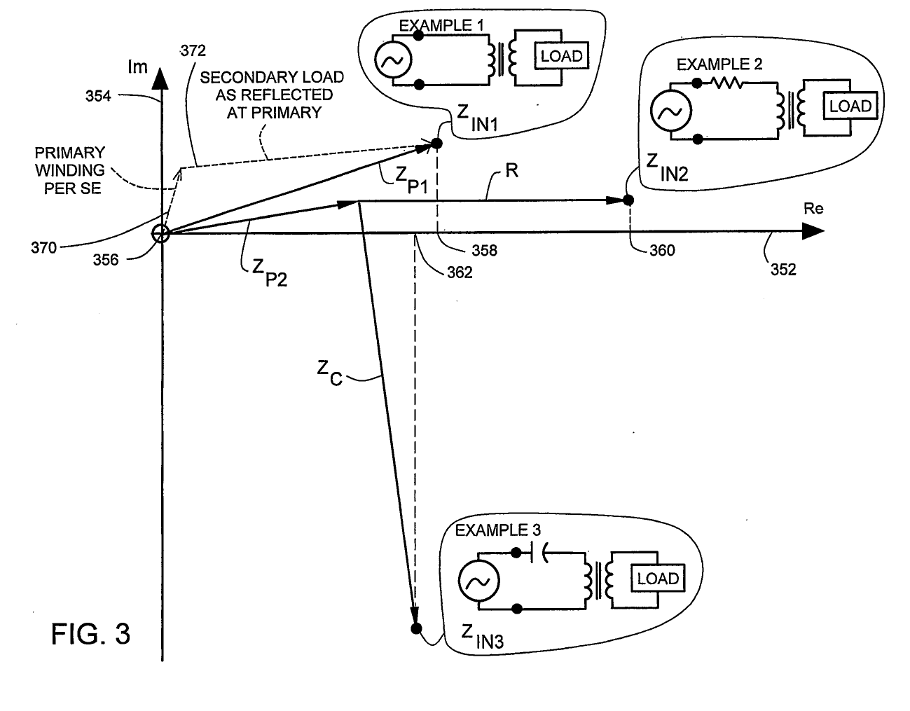

As described in more detail below in connection with FIG. 3, the capacitor 312 has an impedance ZC that is selected in consideration of the power line frequency and an impedance ZP on the transformer primary winding 314 in order to provide low power consumption and high efficiency, and to enable miniaturization of a transformer 316.

The transformer 316 includes a secondary winding 320 that is preferably electrically insulated from the primary winding 314. The secondary winding 320 connects to a rectifier bridge 322. The secondary winding 320 provides AC excitation to the rectifier bridge 322, and the rectifier bridge 322 rectifies the excitation and provides rectified (DC) excitation at rectifier output conductors 324, 326. The rectifier bridge 322 can comprise a full wave bridge of rectifier diodes (D1, D2, D3, D4) and provide a full wave rectified output at output conductors 324, 326 as illustrated. The rectifier 322 can alternatively comprise only two rectifier diodes in an instance where the secondary winding 320 is center-tapped and provide a full wave rectified output at output conductors 324, 326. The rectifier bridge 322 can alternatively comprise a single rectifier diode and provide a half wave rectified output at output conductors 324, 326.

A DC filter capacitor (C2) 328 is connected to output conductors 324, 326 to reduce AC ripple in the rectified output. A regulator 330 is also connected to the output conductors 324, 326 to regulate a DC output voltage at DC output contacts 332, 334. It will be understood by those skilled in the art that the DC load connected to the DC output contacts 332, 334 can include a DC filter capacitor, a regulator, or both, making it unnecessary to include DC filter capacitor 328 or regulator 330 in the housing 302 itself. The regulator serves to maintain the output voltage constant with changes in the load current and the variations of the AC input voltage, as for example when the input is 90-280 VAC. The regulator 330 can be a series regulator, a shunt regulator or other known type of regulator. In the example illustrated, an exemplary shunt regulator is shown that comprises a voltage divider (R2, R3) providing a reference voltage 336 to a shunt regulator integrated circuit 338. The adjustable regulator integrated circuit 338 is preferably a type TL431 adjustable precision shunt regulator from ON Semiconductor of Denver, Colo. Some advantageous features of the converter circuit 300 are described below in connection with FIG. 3. In FIG. 2, and throughout the application, various regulators 330 are identified by a stippled background to better distinguish the regulators 330 from other components.

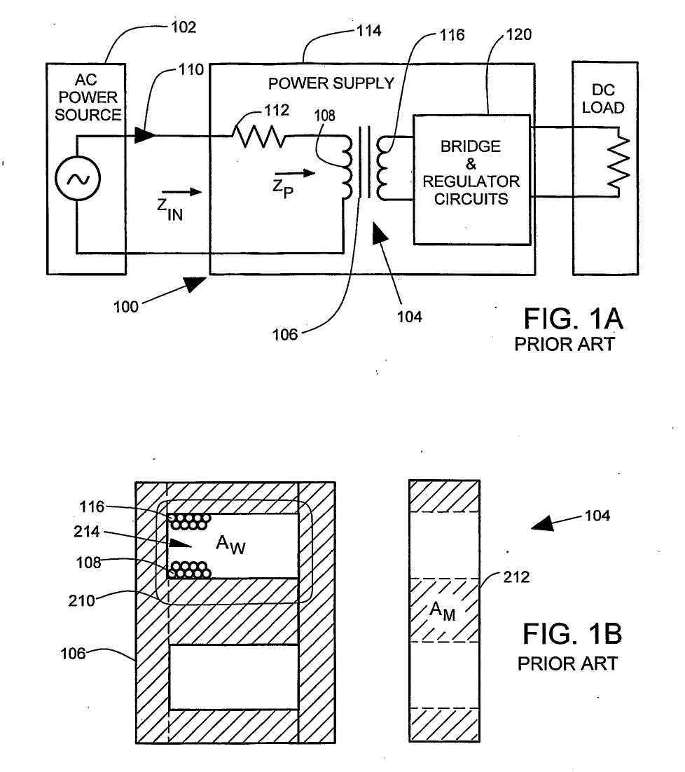

FIG. 3 graphically illustrates AC input impedances ZIN1 (example 1), ZIN2 (example 2), ZIN3 (example 3) that are presented as a load to an AC power source. Example 1 is the circuit in FIG. 1A with resistor 112 at zero ohms, in other words, short circuited. Example 2 is the circuit in FIG. 1A with resistor 112 at a non-zero resistance so that a significant portion of the AC line voltage is dropped across resistor 112. Example 3 is the circuit of FIG. 2 which includes an AC capacitor 312 in series with a primary winding 314.

FIG. 3 provides a transform plane representation of complex impedances. A horizontal axis 352 represents a series resistive, heating, or real component of impedance. A vertical axis 354 represents a series reactive, lossless, or imaginary component of impedance. An origin 356 represents zero AC input impedance. The converter circuit examples 1, 2, 3 each have approximately the same number of primary winding ampere-turns, each delivers approximately the same amount of power to a DC load, but each draws a different amounts of power from the AC line, and each has a different amount of internal heating.

In Example 1 (FIG. 1A), the primary winding 108 connects directly to the AC power source 102, there is no added series impedance (i.e., resistor 112 is zero ohms), and the primary winding 108 has a large number of turns N that carry a primary current I through a primary wire with a wire cross sectional area A. The primary wire is extremely small diameter and subject to breakage, making the transformer difficult to manufacture.

In Example 2 (FIG. 1A), the primary winding is connected to the AC power source 102 through a resistor 112 that has a resistance R that is larger than a primary winding impedance ZP=ZP2. In Example 2, the AC voltage applied to the primary winding 108 is reduced, and the primary winding 108 has a reduced number of turns (N×0.707, for example) that carry an increased current (I×1.414) for example. In Example 2, the primary wire has a larger cross sectional area (A×2, for example). The power resistor 112 dissipates a large amount of power, leading to low efficiency and overheating the power supply in Example 2.

In Example 3 (FIG. 2), the primary winding is connected to the AC power source 102 through a capacitor 312 that has a capacitance C. In Example 3, the AC voltage applied to the primary winding 314 is reduced, and the primary winding 314 has a reduced number of turns (N×0.707, for example) that carry an increased current (I×1.414) for example. In Example 3, the primary wire has a larger cross sectional area (A×2, for example). The capacitor 312 dissipates negligible power and provides a reduced voltage to the primary winding 314, allowing a larger diameter wire to be used that is relatively free of breakage during transformer manufacture. The capacitor 312, which has a negligible power loss, does not overheat the power supply in Example 3.

Impedances of various circuit components in the power supply circuits of FIGS. 1A, 2 are illustrated as vectors in the FIG. 3 transform plane. A vector ZC represents an impedance of the capacitor 312 in FIG. 3. A vector R represents an impedance (resistance) of the resistor 112 in FIG. 1A. A vector ZP1 represents an input impedance on the transformer primary winding 108 of N turns in FIG. 1A when resistor 112 is zero ohms. A vector ZP2 represents an input impedance of (N×0.707) turns on the transformer primary winding 108 in FIG. 1A when the resistor 112 has a resistance (impedance) R>|ZP2|. The vector ZP2 also represents an input impedance of (N×0.707) turns on the transformer primary winding 314 in FIG. 2 that is used in series with capacitor 312 that has a capacitive impedance |ZC|>|ZP2|.

It will be recognized by those skilled in the art that the impedance encountered at a primary winding such as impedance ZP1 has a first impedance portion 370 that is due to the primary winding per se (magnetizing impedance), and also a second impedance portion 372 that is due to secondary load as it is reflected at the primary impedance. As illustrated in FIG. 3, the magnetizing impedance 370 and the reflected load impedance 372 add up vectorially to impedance ZP1.

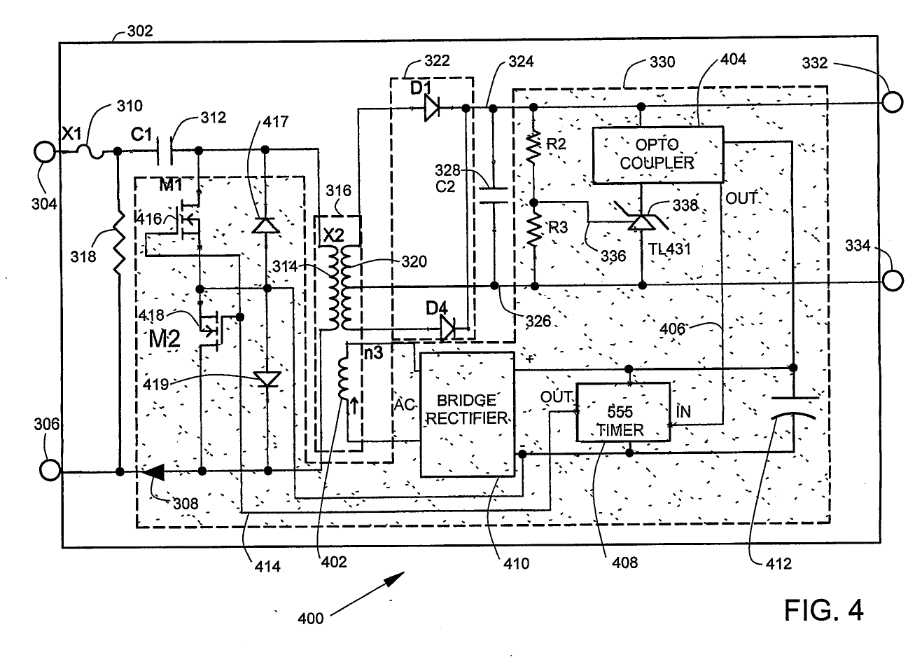

AC input impedances ZIN1, ZIN2, ZIN3 of the comparable power supply Examples 1, 2, 3 are represented as dots on the transform plane. The input impedances are the vector sums of the series components. The AC input impedances can be represented as vectors (not shown) extending from the origin 356 to the dots. ZIN1 represents the input impedance ZIN illustrated in FIG. 1A with RSERIES=0 and ZP=ZP1. ZIN2 represents the input impedance ZIN illustrated in FIG. 1A with ZP=ZP2, R>ZP2 and ZP2<ZP1. ZIN3 represents the input impedance ZIN illustrated in FIG. 2 with ZP=ZP2, ZC>ZP2 and ZP2<ZP1. As can be seen by inspection of FIG. 3, Example 1 has a resistive power consumption 358. In Example 2, the number of winding turns is reduced by use of a series resistor, but the resistive power consumption is increased greatly to power loss 360. In Example 3, the number of winding turns is reduced by use of a capacitor, and the power consumption is reduced to a reduced power consumption level 362. The power supply circuit in Example 2 is preferred for low power levels below about 50 milliwatts where the lower efficiency (compared to FIGS. 4-7) does not cause excessive heating of the converter circuit.

FIG. 3 illustrates that use of an AC capacitor in series with a transformer primary allows an adequate number of ampere-turns for excitation of a low power miniature transformer with increased primary wire size, low primary voltage and low power consumption in a miniature housing that is free of overheating.

FIG. 4 illustrates a miniaturized converter circuit 400 that is similar to the miniature converter circuit 300 illustrated in FIG. 2. The converter circuit 400 can be used at higher power levels and provides higher efficiency than the converter circuit illustrated in FIG. 2. Reference numbers used in FIG. 4 that are the same as reference numbers used in FIG. 2 indicate the same or functionally similar features.

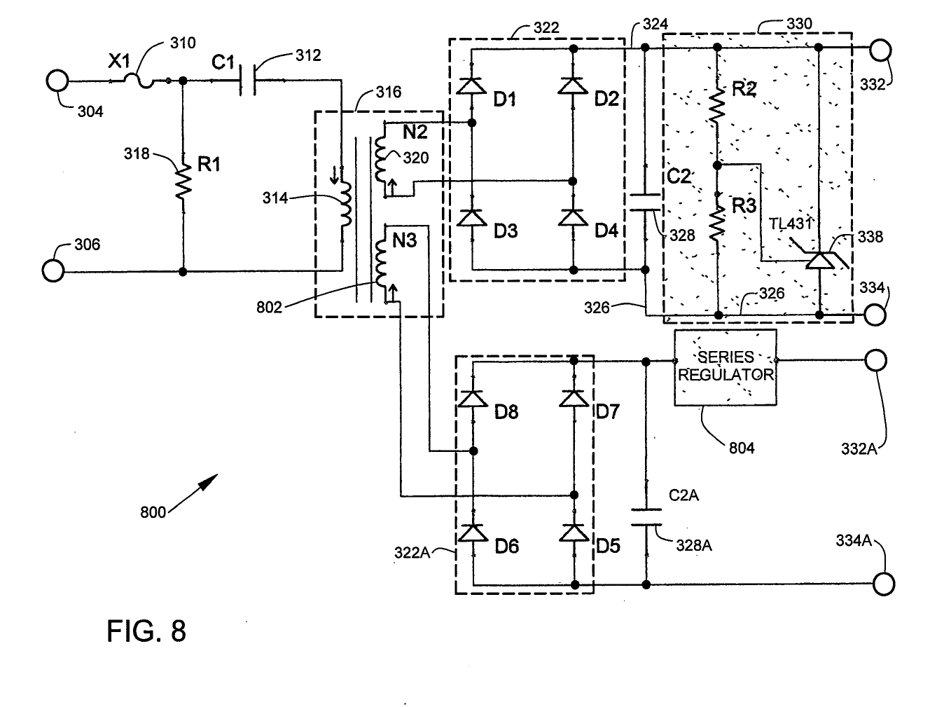

FIGS. 4-7 illustrate converter circuits that can be used at higher power levels and that provide higher efficiency in comparison to the converter circuits illustrated in FIGS. 2, 8.

In FIG. 4, a secondary winding 320 is center-tapped, and a bridge rectifier 322 includes two rectifier diodes D1 and D4. In contrast with FIG. 4, in FIG. 2 a secondary winding 320 is not center-tapped and the bridge rectifier 322 requires four rectifier diodes D1, D2, D3, D4. A person of ordinary skill in the art would recognize that either rectifier arrangement can be used in a converter circuit, dependent on factors such as the availability of a center tap on the transformer and the desired DC output voltage.

In FIG. 4, the transformer 316 includes an auxiliary secondary winding 402 that is galvanically isolated from the center-tapped secondary winding 320. The secondary winding 402 provides energization for a regulator circuit 330 in FIG. 4. In contrast with FIG. 4, the converter circuit 300 in FIG. 2 does not include an auxiliary secondary winding.

In FIG. 4, a regulator circuit 330 regulates power supply voltage at DC output contacts 332, 334 by varying current through a shunt regulator that is connected in parallel with transformer primary 314. In contrast with FIG. 4, the converter circuit 300 in FIG. 2 regulates power supply voltage at DC output contacts 332, 334 by varying current through a shunt regulator 338 that is connected in parallel with the DC output contacts 332, 334.

In the regulator 330 in FIG. 4, current through a regulator integrated circuit 338 varies as a function of DC output voltage, and the current passes through an input of optocoupler 404. The optocoupler 404 provides galvanic isolation between circuits coupled to the DC output and circuits coupled to the AC input. An output of the optocoupler 404 couples along line 406 to an input of a type 555 timer 408. A bridge rectifier 410 (connected to isolated secondary winding 402) and a filter capacitor 412 provide a galvanically isolator supply voltage for energizing the timer 408 and the output of the optocoupler 404. An output of the timer 408 on line 414 couples to the gates (inputs) of field effect transistors 416, 418. The timer 408 actuates the field effect transistors 416, 418 with voltage pulses to bypass current away from the primary winding 314. As explained above in connection with Example 3 in FIG. 3, the impedance of the primary winding 314 is low in comparison to the impedance of the capacitor 312. The AC voltage at the primary winding 314 is thus considerably less than the line voltage, and relatively low cost, low voltage field effect transistors 416, 418 and commutating diodes 417, 419 can be used. With the regulation arrangement shown in FIG. 4, so-called “universal line voltage” performance can be easily accomplished. In other words, the converter circuit 400 can be connected, without adjustment, to any line voltage in the worldwide AC power voltage range of about 90-250 VAC and operate with high efficiency over that entire range. With the shunt regulation arrangement in FIG. 4, AC current is shunted off before it can reach the transformer, and heating is reduced.

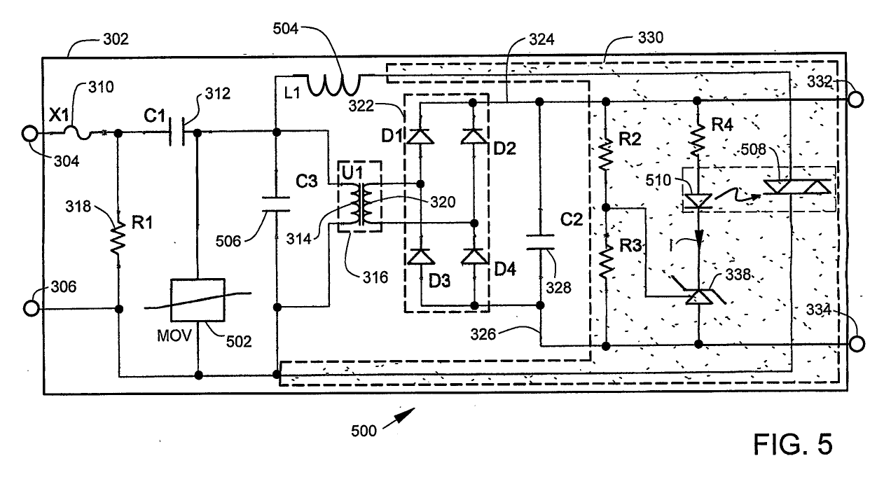

FIG. 5 illustrates a miniaturized converter circuit 500 that is similar to the miniature converter circuits illustrated in FIGS. 2, 4. Reference numbers used in FIG. 5 that are the same as reference numbers used in FIGS. 2, 4 indicate the same or functionally similar features.

In FIG. 5, a metal oxide varistor (MOV) 502 is connected to a transformer primary 314. A capacitor 506 is also connected to a transformer primary 314. As explained in more detail below, the components 502, 506 reduce power line transients across the transformer primary 314.

In FIG. 5, a regulator circuit 330 regulates power supply voltage at DC output contacts 332, 334 by varying current through an optically isolated triac 508 that is connected in parallel with transformer primary 314. The optically isolated triac 508 functions as a shunt regulator across the transformer primary 314. In contrast with FIG. 2, the circuit 200 in FIG. 2 regulates power supply voltage at DC output contacts 332, 334 by varying current through a shunt regulator 338 that is connected in parallel with the DC output contacts 332, 334. FIG. 5 provides higher efficiency than FIG. 2. FIG. 5 is preferred for higher power applications, whereas FIG. 2 is preferred for lower power applications.

In FIG. 5, an error amplifier sensor (in the shunt regulator integrated circuit 338) is used to generate a current I proportional to the error from a reference target. This current is used to drive a light emitting diode (LED) 510 that is used to optically trigger the triac 508 after a threshold in the triac output voltage is reached. The triac 508 is connected across the primary winding 314 of the transformer 316. When the triac 508 fires (turns ON), presenting a low impedance element across the primary, current is diverted from the transformer primary 314 and the load to the triac 508, and flows back to the utility return contact 306. This low impedance (ON) state of the triac is maintained until the current from the capacitor 312 changes polarity. When there is excess voltage available from the utility as controlled by the capacitor 312, the voltage regulator 330 causes an AC current that is slightly different from a sinusoid because of the step change in voltage across the capacitor 312. However since this change is voltage is small compared to the total input utility voltage, the resulting deviation of the input current from a sinusoid is minimal. The extra power that would have been delivered to the transformer and load is shunted and absorbed by the reactive component, capacitor 312. Since the reactive component (capacitor 312) is not dissipative, the resulting efficiency of the power supply is higher. There is, however, the small overhead loss in the form of the conduction loss of the triac.

The power capability of converter circuit 500 is limited by the current capability of the optically driven triac combination, which is preferably an integrated circuit MOC3042. For higher power applications, MOC3042 maybe used as a gate drive for a higher power rating triac across the primary transformer winding.

For loads where the control for the power supply is such that the triac fires close to 180 degrees in the duty cycle, the current from the reactive component during the portion of the cycle is monotonically decreasing. On the other hand, the magnetizing current for the transformer is increasing and close to its maximum and thus in this portion of the power cycle, the load current could possibly be starved. It is observed that under this condition the control of the voltage regulator is irregular and could lead to higher ripple output voltage. Capacitor 506 serves to avoid these problems by storing reserve charge such that there will be current to support the magnetizing current demand and prevent the irregular behavior of the regulator 330.

The current from the utility line is almost a constant current source and a perfect sinusoid because most of the impedance to the power supply is due to the reactance of capacitor 312. Thus the power supply causes minimal harmonic distortion on the utility input currents. Shunting of the current from the transformer to the triac however generates a spike of current in the reactive component if it is a capacitor. This spike of current is due to the change in the voltage across the reactive capacitive element due to the triac turning ON. The waveform of this current would be dependent on the characteristic of the resulting voltage waveform across the input capacitor. If the triac switches instantaneously, the current would be a large spike, delta function. This produces a large EMI conducted noise with very wide spectrum. If the triac switches with a ramp characteristic of duration tau, the current spike would be a rectangular pulse of duration tau. The resulting conducted emission current due to this pulse has a asymptotic current noise versus frequency profile that would be constant from 120 Hz to 1/(pi*tau) where it would decrease at 20 db/dec in the logarithmic scale. The magnitude of this conducted emission can therefore be reduced if tau were increased such that the 20 db/dec rolloff occurs way before the significant lower frequency of interest for EMC conducted emission which is 150 khz. An inductor 504 in series with the triac serves this purpose. The inductor 504 could also be in series with the capacitor 506 before it is connected to the transformer primary 314.

In both FIGS. 4-5, line current is shunted through a switching device (MOSFET or TRIAC) to provide shunt regulation. The switching devices in FIG. 4-5 are coupled to an AC power line and are not isolated from AC power lines by the transformer 316. The switching devices in FIGS. 4-5 are thus subject to damage from transients.

In actual utility lines, transients in the form of induced lightning voltage strikes or noise spikes caused by local loads such as motors tuning ON/OFF from household appliances such as washing machines, refrigerators, dishwashers gets coupled directly through the capacitor 312 into the transformer and switching devices and could be large and the cumulative effect of such transients could cause the switching device in FIGS. 4-5 to fail. The transformer is relatively immune to saturation due to the transient because of the high frequency of the disturbance. Failure would be due to the breakdown of the isolation barrier between the primary and secondary. To avoid this, the embodiments in FIGS. 4-5 includes transient arresting device such as an MOV 502 (metal oxide varistor) or transient voltage suppressor diodes 417, 419 to limit the voltage excursion across the transformer. Because MOVs suffer from long term degradation due to cumulative high energy strikes where the degree of degradation is a function of the cumulative energy of all the strikes, it is advantageous to select the MOV 502 to have a higher energy capacity or use transient voltage suppressors diodes.

Whenever there are reactive elements such as capacitor 312, inductor 504, capacitor 506 and primary 314, the possibility of unwanted resonance also occurs. This resonance is suppressed so that damping coefficient is close to 1 by the resistance of the polychem fuse 310.

In the prior art circuit of FIG. 1A, efficiency can be degraded when the power supply operates at the universal range for example of 90VAC to 280VAC because the series regulator needs to absorb the added voltage drop due to the increase in input voltage. This degradation is greatly reduced in the converter circuits presently disclosed. Power supplies for printers, fax machine and battery chargers for laptops have improved efficiency with the presently disclosed converter circuits are used.

The embodiment shown in FIG. 5 can also be modified such that the triac MOC3042 is connected across a secondary winding 320. In this modification, the efficiency would be degraded compared to FIG. 5 because of the addition of the power loss due to the resistance of the primary and secondary winding during the shunting of the power from the load. This modification, however, has the benefit that the inductor 504 used for EMC control can be eliminated, since it is effectively replaced by the naturally occurring leakage inductance of the primary and secondary windings of the transformer. Because there is natural protection by the transformer on high voltage, high frequency content inputs due to the leakage inductances, the transient protection of MOV or voltage suppressor diodes is not needed in this modification.

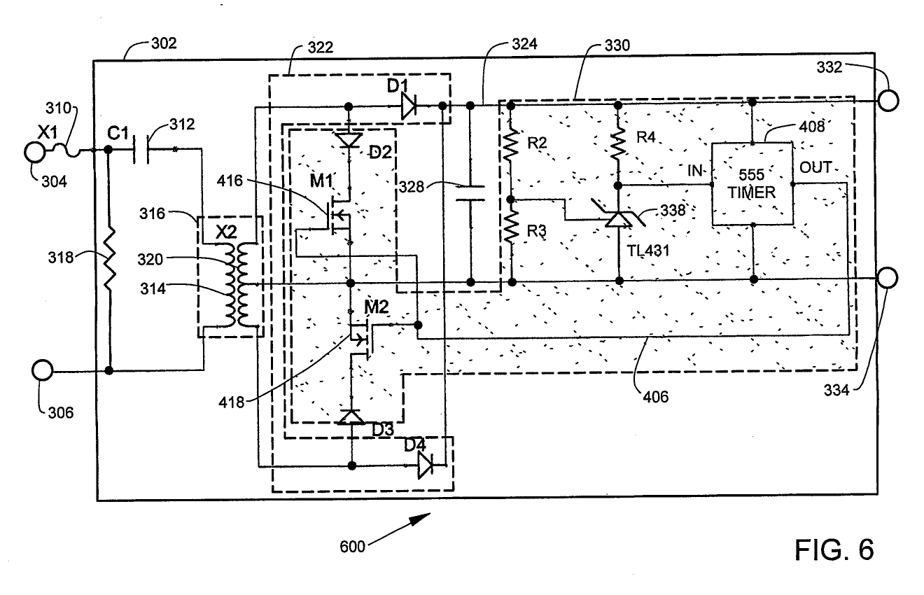

Similar to the modification described above, Mosfet switches can be used in place of the triac, as described below in connection with FIG. 6.

FIG. 6 illustrates a miniaturized converter circuit 600 that is similar to the miniature converter circuit 300 illustrated in FIG. 2. Reference numbers used in FIG. 6 that are the same as reference numbers used in FIG. 2, 4, 5 indicate the same or functionally similar features.

In FIG. 6, a secondary winding 320 is center-tapped, and a bridge rectifier 322 includes two rectifier diodes D1 and D4.

In FIG. 6, the fuse 310 is also located external to housing 302 as illustrated. In FIG. 6, the transformer 316 does not includes an auxiliary secondary winding since shunt regulation is performed across the secondary winding 320 rather than the primary winding, and galvanic isolation is not needed in a regulator circuit 330. In FIG. 6, a regulator circuit 330 regulates power supply voltage at DC output contacts 332, 334 by varying current through a shunt regulator that is connected in parallel with transformer secondary 320.

In the regulator 330 in FIG. 6, current through a regulator integrated circuit 338 varies as a function of DC output voltage on line 324 and the regulator 338 provides a control voltage to an input of a timer 408. No optocoupler is provided since all regulator components are on the secondary side and no galvanic isolation is needed. An output of the timer 408 on line 406 couples to the gates (inputs) of field effect transistors 416, 418. The timer 408 actuates the field effect transistors 416, 418 with voltage pulses to load the secondary winding 320. With the regulation arrangement shown in FIG. 6, so-called “universal line voltage” performance can be easily accomplished. In other words, the converter circuit 600 can be connected, without adjustment, to any line voltage in the worldwide AC power voltage range of about 90-250 VAC and operate with high efficiency over that entire range.

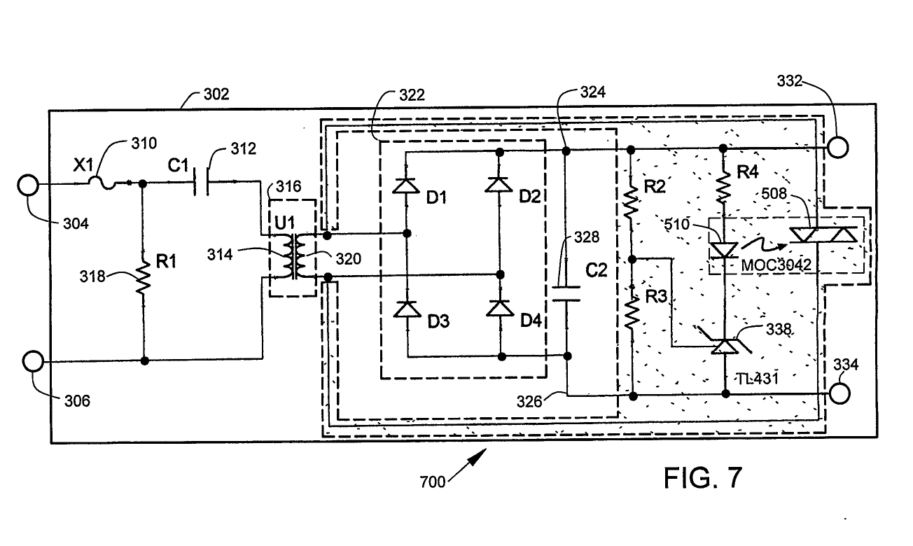

FIG. 7 illustrates a miniaturized converter circuit 700 that is generally similar to the miniature converter circuit 600 illustrated in FIG. 6 above, however, an optically triggered triac 508 is used for a shunt regulator across a secondary winding 320 instead of the mosfets of FIG. 6. Reference numbers used in FIG. 7 that are the same as reference numbers used in FIG. 2, 4, 5, 6 indicate the same or functionally similar features.

In FIG. 7, a capacitor (such as capacitor 506 in FIG. 5) is not needed unless the leakage inductance provided by the transformer is inadequate for EMC control. For higher power applications, where the MOC3042 triac 508 (with optical triggering by light emitting diode 510) has inadequate current carrying capability, the triac 508 can be used to drive a gate of a higher power capability triac that serves as the shunt regulator element. The circuit in FIG. 7 has the advantage of simple circuit topology with only a small power loss penalty.

FIG. 8 illustrates an embodiment of a converter circuit 800 which provides two galvanically isolated DC outputs that are each separately regulated. The converter circuit 800 is generally similar to the miniature power supplies illustrated in FIGS. 2, 4-7. Reference numbers used in FIG. 8 that are the same as reference numbers used in FIG. 2, 4-7 indicate the same or functionally similar features.

In FIG. 8, a main (higher power) output on contacts 332A, 334A supplies electronic equipment (such as a television set) which can be turned on or off by a remote control. A remote control (lower power) output on contacts 332, 334 supplies remote control circuitry (such as an infrared receiver for a remote control in the television) which is continuously energized and serves to turn the higher power equipment on or off. In FIG. 8, the transformer has a first secondary winding 320 for energizing lower power circuitry and a second secondary winding 802 for energizing higher power circuitry. The secondary winding 320 connects to a 4 diode bridge 322 and a regulator 330 that are similar to those described above in connection with FIG. 2. The secondary winding 802 connects to a 4 diode bridge 322A and a DC filter capacitor 328A and a series regulator 804 to provide a second DC output on contacts 332A, 334A.

The various embodiments of converter circuits illustrated in FIGS. 2-8 can be used in a wide variety of applications where DC power is converted from an AC power source in a low power range at or below one watt. These applications include both power supplies and battery chargers. Features shown in one embodiment can be appropriately applied to another embodiment.

In each of the disclosed embodiments in FIGS. 2, 4-8, An AC to DC converter circuit 300, 400, 500, 600, 700 or 800 comprises AC input contacts 304, 306 coupling to an AC line voltage, and DC output contacts 332, 334 coupling to a DC load. Each of the converter circuits includes a transformer 316 with a primary winding 314 and a secondary windings 320. Each of the converter circuits includes a rectifier bridge 322 coupled to the secondary winding 320. Each of the converter circuits includes a DC filter capacitor 328 coupled to the rectifier bridge 322. Each of the converter circuits includes a voltage regulator 330 coupled to the DC filter capacitor 328 and to the DC output contacts 332, 334. In each of the converter circuits, an AC reactance (AC capacitor 312) is coupled in a series circuit with the primary winding 314 and the AC input contacts 304, 306. The AC reactance (AC capacitor 312) limits AC excitation voltage at the primary winding 314 to less than the AC line voltage at contacts 304, 306. It will be understood by those skilled in the art that the AC capacitor 312 provides a reactance in the primary winding circuit, and that an inductor, which also provides a reactance, can be substituted for the capacitor 312 while achieving the same benefits of low power consumption and reduction in the number of primary winding turns and increase in the wire size of primary winding turns.

The following are advantages of the embodiments disclosed over conventional wall plug power supplies and switch mode power supplies:

1. Low Cost

2. Approximately the same size as wall plug power supplies operating at the same power levels. For lower power applications, the arrangement shown in FIG. 2 can be used, resulting in smaller size.

3. Higher efficiency than equivalent wall plug power supplies operating at the same power levels.

4. Transformer approaches theoretical minimum size of transformer for low power applications, with additional window area to accommodate larger size windings.

5. Low component count with resultant high reliability.

6. Better efficiency than switch mode power supply at low power levels.

7. Use of mostly passive components and uses simple and long proven components adding reliability.

8. Low frequency switching (120 Hz) resulting in lower EMC noise

9. Easy EMC control

10. Reactive component is a capacitor, so power factor is leading and almost zero, which is advantageous to utility supplying power to other loads that are typically lagging.

11. Input current almost sinusoidal giving low input current harmonic distortion.

Although the present invention has been described with reference to preferred embodiments, workers skilled in the art will recognize that changes may be made in form and detail without departing from the spirit and scope of the invention.

What is claimed is:

1. An AC to DC converter circuit, comprising:
AC input contacts couplable to an AC line voltage, and DC output contacts couplable to a DC load;
a transformer having primary and secondary windings;
a rectifier bridge coupled to the secondary winding;
a DC filter capacitor coupled to the rectifier bridge;
a voltage regulator coupled the DC filter capacitor and to the DC output contacts; and
an AC reactance coupled in a series circuit with the primary winding and the AC input contacts, the AC reactance limiting AC excitation voltage at the primary winding to less than the AC line voltage.

2. The AC to DC converter circuit of claim 1 wherein the AC reactance comprises an inductor.

3. The AC to DC converter circuit of claim 1 wherein the AC reactance comprises an AC capacitor.

4. The AC to DC converter circuit of claim 3 wherein the secondary winding is a center tapped winding, and wherein the rectifier bridge comprises two diodes.

5. The AC to DC converter circuit of claim 3 wherein the second winding is not a center tapped winding, wherein the rectifier bridge comprises four diodes.

6. The AC to DC converter circuit of claim 3 wherein the rectifier bridge comprise schottky diodes.

7. The AC to DC converter circuit of claim 3 wherein the voltage regulator is a series regulator.

8. The AC to DC converter circuit of claim 3 wherein the voltage regulator is a shunt regulator.

9. The AC to DC converter circuit of claim 8 wherein the shunt regulator is coupled to the primary winding and shunts current around the primary winding to provide regulation.

10. The AC to DC converter circuit of claim 8 wherein the shunt regulator is coupled to the secondary winding and shunts current provided by the secondary winding to provide regulation.

11. The AC to DC converter circuit of claim 8 wherein the shunt regulator is coupled to DC output contacts and shunts DC current to provide regulation.

12. The AC to DC converter circuit of claim 1 wherein the AC reactance has an impedance that is larger than a primary winding impedance to reduce AC voltage at the primary winding.

13. The AC to DC converter circuit of claim 12 wherein the primary winding has a reduced number of primary turns commensurate with the reduced AC voltage.

14. The AC to DC converter circuit of claim 13 wherein the reduced number of primary turns has an increased wire diameter commensurate with an available window size of the transformer.

15. The AC to DC converter circuit of claim 1 wherein the voltage regulator comprises a switching regulator with a switch that switches at a rate of no more than twice the AC line frequency.

16. The AC to DC converter circuit of claim 15 and further comprising an inductor coupled in series with the switch for controlling electromagnetic interference.

17. The AC to DC converter circuit of claim 1 adapted to charge a lithium ion battery.

18. A method of AC to DC conversion, comprising:
providing AC input contacts couplable to an AC line voltage, and DC output contacts couplable to a DC load;
providing a transformer having primary and secondary windings;
providing a rectifier bridge coupled to the secondary winding;
providing a DC filter capacitor coupled to the rectifier bridge;
providing a voltage regulator coupled the DC filter capacitor and to the DC output contacts; and
providing an AC reactance coupled in a series circuit with the primary winding and the AC input contacts, the AC reactance limiting AC excitation voltage at the primary winding to less than the AC line voltage.
